(19) United States
(12) Patent Application Publication
(10) Pub. No.: US 2017/0297402 A1
(43) Pub. Date: Oct. 19, 2017

(54) DETECTION AND RECONSTRUCTION OF SUSPENSION HEIGHT SENSOR FAULTS

(71) Applicant: GM GLOBAL TECHNOLOGY OPERATIONS LLC, DETROIT, MI (US)

(72) Inventors: SHIH-KEN CHEN, TROY, MI (US); AMIR KHAJEPOUR, WATERLOO (CA); WILLIAM MELEK, MISSISSAUGA (CA); REZA ZARRINGHALAM, WATERLOO (CA); EHSAN HASHEMI, WATERLOO (CA)

(21) Appl. No.: 15/097,570

(22) Filed: Apr. 13, 2016

(51) Int. Cl. B60G 17/0185; B62D 15/02; B60T 8/175; B60T 8/1755; H04W 4/00; H04L 12/26

(52) U.S. Cl. CPC B60G 17/0185; H04W 4/005; H04L 43/16; B60T 8/175; B60T 8/1755; B62D 15/025

(57) ABSTRACT

A method of reconstructing a detected faulty signal. A suspension height fault is detected by a processor. A signal of the detected faulty suspension height sensor is reconstructed using indirect sensor data. The reconstructed signal is output to a controller to maintain stability.

### BACKGROUND OF INVENTION

An embodiment relates to state of detecting sensor faults and correcting sensor signals, specifically, suspension height sensors.

Diagnostic monitoring of vehicle stability systems include a variety of sensors monitoring various dynamic conditions of the vehicle. Such systems employ various types of sensors for identifying a status condition of an operation. For example, rollover stability control systems utilize roll rate sensors, pitch rate sensors, and suspension height sensors for detecting a vehicle's instability. In response to detecting the vehicle's instability, corrective actions may be deployed by a vehicle stability control system by actuating one or more vehicle operations (e.g., driving, braking, speed control) to counter the instability condition.

When the sensors are utilized to sense for conditions that contribute to the instability, such sensors are often considered critical. As a result, it must be known when these sensors become faulty. Typically, to ensure continued operation of the function so that the operator can pull over or have the car inspected, such a system often utilizes redundant sensors. Redundant sensors are a same set of sensors performing the same function as the primary sensor but are used for backup in the event a primary sensor fails so that a backup sensor may be immediately utilized to provide reliable measurements. Although hardware redundancy (i.e. multiple sensors measuring a specific variable) can ensure reliable operation of vehicle subsystems despite sensor failures, it is not a preferable solution in the automotive industry due to its cost and installation challenges.

### SUMMARY OF INVENTION

An advantage of an embodiment is a detection of the fault of a suspension height sensor, the identification of which specific sensor is at fault, and reconstruction of the faulted signal by combining vehicle kinematic and dynamic models with unknown input observers and estimated vehicle states to detect and reconstruct the faults. Robustness to road grade and road bank disturbances is an advantage of the proposed structure. The technique described herein utilizes virtual sensor values and measures sensor values to determine a residual. The residual is compared to a threshold for determining whether a suspension height sensor fault is present. If a suspension height sensor fault is determined, then a technique is applied to determine which suspension height sensor is faulty. The technique utilizes a model and observer to identify roll faults and pitch faults at each of the locations of the suspension height sensors. Based on the fault states at each of the respective locations, a fault signature is identified and is compared to a plurality of predetermined fault signatures for determining which of the suspension height sensors may be faulty. In response to determining which of the suspension height sensors have faults, the faulted signal is reconstructed for use by the system to maintain stability.

An embodiment contemplates a method of reconstructing a detected faulty signal. A suspension height sensor fault is detected by a processor. A signal of the detected faulty suspension height sensor is reconstructed by a processor using indirect sensor data. The reconstructed signal is output to a controller to maintain stability.

### BRIEF DESCRIPTION OF DRAWINGS

FIG. 1 illustrates a pictorial illustration of a vehicle equipped with stability control sensors

FIG. 2 is a block diagram of a vehicle stability control system.

FIG. 3 is a flowchart of a general process flow technique.

FIG. 4 is a flowchart of the detailed process of detecting a faulty sensor and reconstructing the signal.

FIG. 5 illustrates sprung mass suspension kinematic model.

FIG. 6 illustrates a fault signature table.

FIG. 7 illustrates a table of reconstructed faults.

### DETAILED DESCRIPTION

The following detailed description is meant to be illustrative in understanding the subject matter of the embodiments and is not intended to limit the embodiments of the subject matter or the application and the uses of such embodiments. Any use of the word “exemplary” is intended to be interpreted as “serving as an example, instance, or illustration.” Implementations set forth herein are exemplary and are not meant to be construed as preferred or advantageous over other implementations. The descriptions herein are not meant to be bound by any expressed or implied theory presented in the preceding background, detailed description or descriptions, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, (e.g., memory elements, digital signal processing elements, logic elements, look-up tables, or the like, which may carry out a variety of functions under the control of one or more microprocessors or other control devices).

When implemented in software, various elements of the systems described herein are essentially the code segments or computer-executable instructions that perform the various tasks. In certain embodiments, the program or code segments are stored in a tangible processor-readable medium, which may include any medium that can store or transfer information. Examples of a non-transitory and processor-readable medium include an electronic circuit, a microcontroller, an application-specific integrated circuit (ASIC), a semiconductor memory device, a ROM, a flash memory, an erasable ROM (EROM), a floppy diskette, a CD-ROM, an optical disk, a hard disk, or the like.

The system and methodology described herein can be utilized to identify faults in sensors, and one of ordinary skill in the art appreciates that an automotive application is merely exemplary, and that the concepts disclosed herein may also be applied to any other system that utilizes suspension height sensing devices.

The term “vehicle” as described herein can be construed broadly to include not only a passenger automobile, but any other vehicle including, but not limited to, rail systems, planes, off-road sport vehicles, robotic vehicles, motorcycles, trucks, sports utility vehicles (SUVs), recreational vehicles (RVs), marine vessels, aircraft, farming vehicles, and construction vehicles.

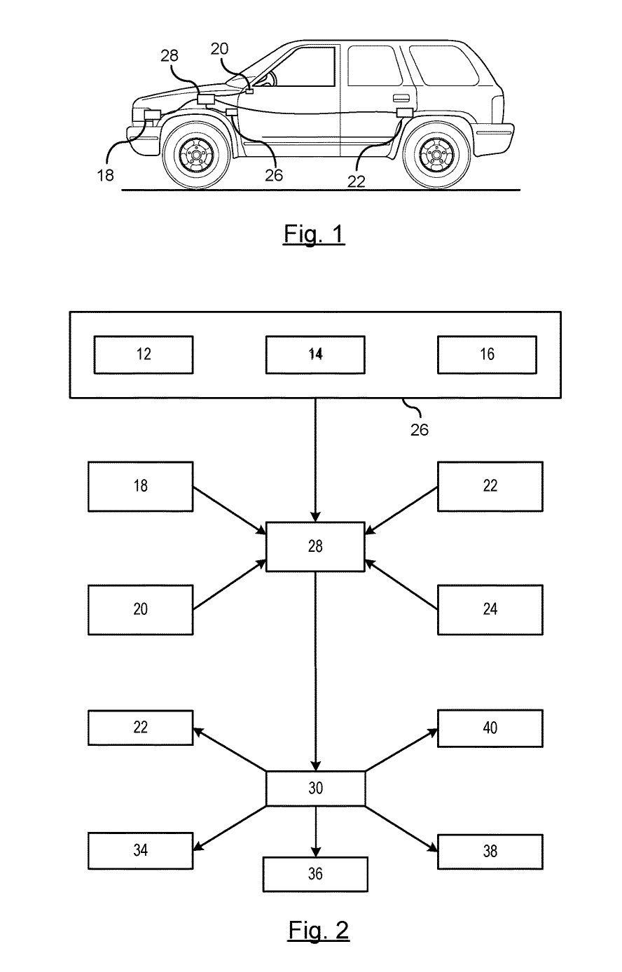

Vehicle stability control systems utilize a plurality of sensors for sensing vehicle operating conditions and employing one or more control systems to counteract or minimize instability conditions. Referring to FIGS. 1 and 2, a vehicle may be equipped with the following sensors that include, but are not limited to, a pitch rate sensor 12, a roll rate sensor 14, and a yaw rate sensor 16, wheel speed sensors 18, steering wheel angle sensors 20, suspension sensors 22, and other sensors 24. The pitch rate sensor 12, roll rate sensor 14, and yaw rate sensor 16, as well as other sensors may be integrated with a single module 26.

A processor 28 receives sensed inputs from one or more of the sensors for processing the sensed input data and determining an instability condition. The processor 28 may be part of an existing system, such as traction control system or other system, or can be a standalone processor dedicated to analyzing data from the one or more sensing devices.

The processor 28 may be coupled to one or more output devices such as a controller 30 for initiating or actuating a control action if based on the analysis applied by the processor 28.

The controller 30 may control a braking system 32 wherein the effects of the instability can be minimized or eliminated using vehicle braking.

The controller 30 may control a traction control system 34 which distributes power individually to each respective wheel for reducing wheel slip by a respective wheel.

The controller 30 may control a cruise control system 36 which can deactivate cruise control or restrict the activation of cruise control when instability is detected.

The controller 30 may control a driver information system 38 for providing warnings to the driver of the vehicle concerning the instability condition. It should be understood that the controller 30, as described herein, may include one or more controllers that control an individual function or may control a combination of functions.

The controller 30 may further control the actuation of a wireless communication device 40 for autonomously communicating the instability condition to other vehicles utilizing a vehicle-to-vehicle or vehicle-to-infrastructure communication system.

The controller 30 may be coupled to various other control systems or other systems

As set forth earlier, the system relies on obtaining fault-free sensory information, and more importantly when a sensor failure occurs. While utilizing redundant sensors may be robust, redundant sensors are costly and require added packaging space. As a result, the following technique allows the system to not have to utilize redundant sensors and reconstruct the sensor signal as a function of virtual sensor data. For example, a suspension height sensor measures a height of a suspension system at a respective location. If the suspension height sensor faults, then incorrect data may be utilized for determining an instability of the vehicle. If a fault is detected, and if no redundant sensors are available, the system must be able to reconstruct the correct signal. Therefore, the first step is determining whether a fault is occurring with the signal. Second, the faulty sensor is identified from the plurality of sensors. Third, if a fault is detected, then reconstruction of the sensed signal must be determined.

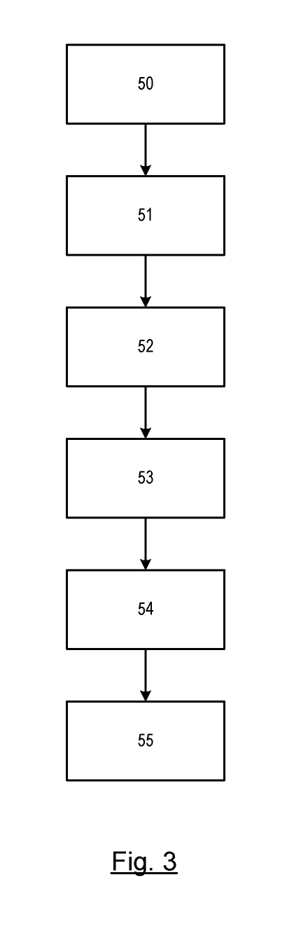

FIG. 3 illustrates a flowchart of a broad overview of the process for detecting a fault and reconstructing a signal from the faulted sensor. In step 50, sensor inputs are provided to the processor for analyzing the sensed data. Information is obtained directly from the sensor dedicated to sensing the respective condition. For example, each suspension height sensor is directly responsible for detecting a suspension height at a respective region of a vehicle. In addition to the measurements from these devices, processor also receives data from other sensor devices that can be used to estimate a suspension height signal. The term virtual as used herein refers to the fact that the data is not received directly from the dedicated sensing device, rather, the data is received from other devices that can indirectly estimate the respective signal.

In step 51, virtual sensor values and residuals are determined. The data from the non-dedicated sensing devices along with a vehicle model is used to calculate the virtual sensor values and residuals. Residuals are defined herein as a difference between the measured values obtained directly from the dedicated sensor devices and virtual sensor values. For example, the residual for the suspension height would be a difference between the measured value from a respective suspension height sensor and the virtual sensor value calculation for the suspension height.

In step 52, a fault threshold is generated. While a fixed threshold may be utilized, an adaptive threshold is preferably utilized. In utilizing fixed thresholds, disturbances, nonlinearities, and uncertainties may trigger spikes or larger than normal residual even when no sensor fault is present. If a large fixed fault threshold is used to account for concerns, then the detection technique will not be able to detect smaller faults and/or will be slower as higher excitation and more time is required for the residuals to pass the large threshold. If a small fixed threshold is utilized, then the threshold may be too small to detect the fault. As a result, such residuals when using fixed fault thresholds may generate false positives.

As a result, an adaptive threshold is used to detect the faults. An adaptive threshold ensures that the false positives are avoided in nonlinear regions and during harsh maneuvers. Moreover, faster detection of the faults in linear regions and during normal maneuvers can be achieved utilizing the adaptive thresholds in addition to enhanced reliable detection of smaller faults.

The adaptive fault threshold is estimated based on the current driving condition and a dynamic region using a current vehicle model and sensory data. A time window is used to calculate the adaptive threshold for enhancing the reliability in transient driving conditions.

In step 53, a fault is detected based on the calculated residuals exceeding the adaptive fault threshold. This technique checks a criterion to reject short-term outliers and avoid false positives. Outliers can arise from abrupt excitations and sudden disturbances. Outliers can also generate short-term residual anomalies. The criterion monitors a time window to reject the outliers and ensure reliable fault detection performance.

In step 54, in response to detecting the faults, the respective signal is reconstructed. The technique reconstructs the failed signal by first identifying which sensor from the plurality of suspension height sensors is fault utilizing a fault signature. Once the fault signature is identified, the faulted sensor signal is reconstructed using virtual sensors.

In step 55, the reconstructed signal is output to a vehicle control system together with the information relating to the faults.

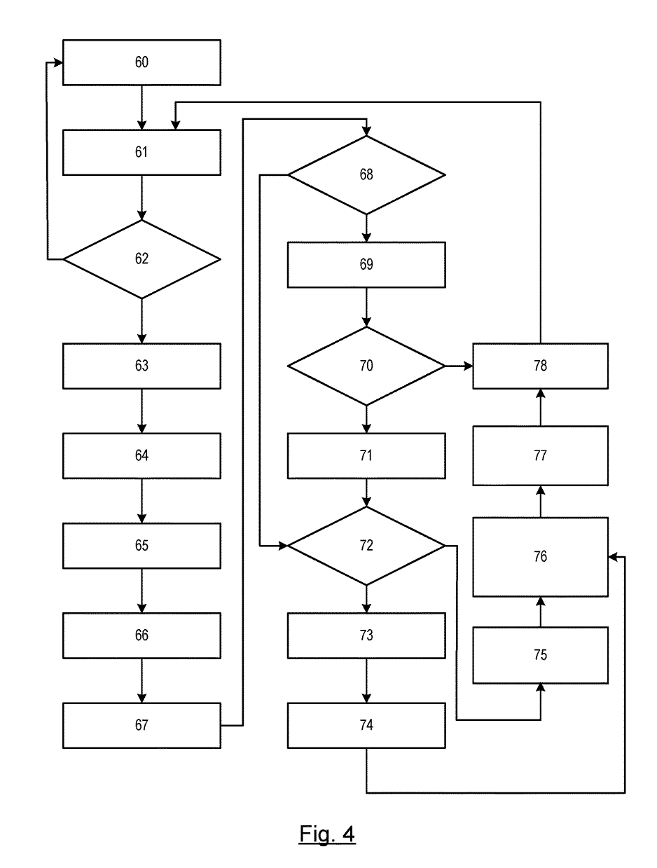

FIG. 4 is a more detailed flowchart for detecting faults and reconstructing the fault signals. Analytical fault detection methods rely on a system model, constraint equations, and collective information from all available sensors to detect the sensor faults. Sensor fault-tolerance design for a system involves satisfying three main requirements that include fault detection, fault isolation, and fault mitigation. Fault detection is a timely and reliable detection of a sensory fault in the system. Fault isolation is an identification/localization of a faulty sensor. Fault mitigation is the reconstruction of the failed sensory signal using the system model and other non-faulty sensors.

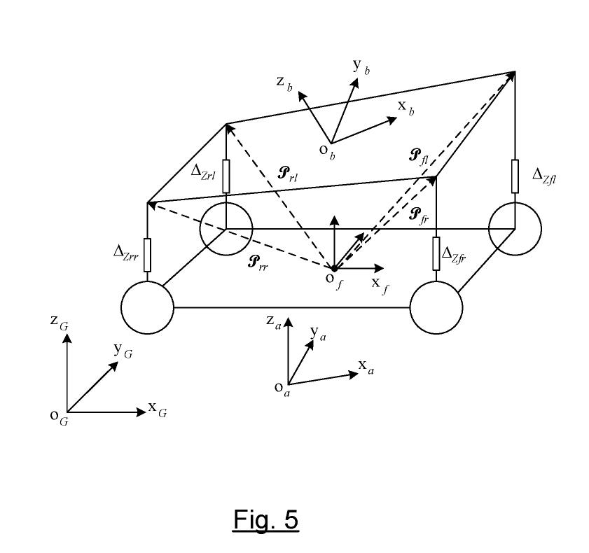

In step, 60, a model is constructed for the monitored system. The model using the roll and pitch dynamics represented as follows:

$$[ \begin{matrix}{\dot{φ}}_{v} \\ {\ddot{φ}}_{v}\end{matrix} ] = [ \begin{matrix}0 & 1 \\ \frac{- {K}_{φ}}{( {I}_{x} + {m}_{s} {H}_{RC}^{2} )} & \frac{- {C}_{φ}}{( {I}_{x} + {m}_{s} {H}_{RC}^{2} )}\end{matrix} ] [ \begin{matrix}{φ}_{v} \\ {\dot{φ}}_{v}\end{matrix} ] + [ \begin{matrix}0 \\ \frac{{m}_{s} {H}_{RC}}{( {I}_{x} + {m}_{s} {H}_{RC}^{2} )}\end{matrix} ] [ {\dot{v}}_{y} + {v}_{x} \dot{ψ} + g sin ( {φ}_{v} + {Φ}_{r} ) ] , and \\ [ \begin{matrix}{\dot{θ}}_{v} \\ {\ddot{θ}}_{v}\end{matrix} ] = [ \begin{matrix}0 & 1 \\ \frac{- {K}_{θ}}{( {I}_{y} + {m}_{s} {H}_{RC}^{2} )} & \frac{- {C}_{θ}}{( {I}_{y} + {m}_{s} {H}_{RC}^{2} )}\end{matrix} ] [ \begin{matrix}{θ}_{v} \\ {\dot{θ}}_{v}\end{matrix} ] + [ \begin{matrix}0 \\ \frac{{m}_{s} {H}_{RC}}{( {I}_{y} + {m}_{s} {H}_{RC}^{2} )}\end{matrix} ] [ - {\dot{v}}_{x} + {v}_{y} \dot{ψ} + g sin ( {θ}_{v} + {Θ}_{r} ) ]$$

where φᵥ and θᵥ are the roll angle and pitch angle of the sprung mass; \dot{φ}ᵥ and \dot{θ}ᵥ are the vehicle roll rate and the pitch rate; H_{RC} and H_{PC} represent a distance between a center of gravity and the roll center and the pitch center, respectively; Iₓ and I_{y} represent moments of inertia about the x axis and y axis of the body coordinate system; \dot{v}ᵣ and \dot{v}_{y} are the rate of change of longitudinal and lateral velocity; vₓ and v_{y} represents longitudinal and lateral velocity, respectively; \dot{ψ} is the yaw rate; Φᵣ is the road bank angle; Θᵣ is the road grade angle, mₛ is the sprung mass; g is the gravitational acceleration; C_{φ} is the roll damping; C_{θ} is the pitch damping; K_{φ} is the stiffness coefficients for roll; and K_{θ} is the stiffness coefficient for pitch. A respective pictorial illustration for a suspension kinematic model is shown in FIG. 5. The following observer is used to the estimate roll state along with an unknown input. The observer for the roll state is as follows:

$${\hat{x}}_{φ} [ k + 1 ] = {E}_{φ} {\hat{x}}_{φ} [ k ] + {F}_{φ} {y}_{φ} [ k \text{:} k + L ]$$

$${\hat{u}}_{φ} [ k ] = {[ \begin{matrix}{B}_{φ} \\ {D}_{φ}\end{matrix} ]}^{- 1} [ \begin{matrix}{\hat{x}}_{φ} [ k + 1 ] - {A}_{φ} {\hat{x}}_{φ} [ k ] \\ {y}_{φ} [ k ] - {C}_{φ} {x}_{φ} k\end{matrix} ]$$

where E_{φ} and F_{φ} are the observer gain matrices for the roll observer, where B_{φ} and D_{φ} are bound gain parameters, where x_{φ}[k] is an estimated roll state, and where û_{φ}[k] is an estimate of an unknown input.

The observer for the pitch state is as follows:

$${\hat{x}}_{θ} [ k + 1 ] = {E}_{θ} {\hat{x}}_{θ} [ k ] + {F}_{θ} {y}_{θ} [ k \text{:} k + L ]$$

$${\hat{u}}_{θ} [ k ] = {[ \begin{matrix}{B}_{θ} \\ {D}_{θ}\end{matrix} ]}^{- 1} [ \begin{matrix}{\hat{x}}_{θ} [ k + 1 ] - {A}_{θ} {\hat{x}}_{θ} [ k ] \\ {y}_{θ} [ k ] - {C}_{θ} {x}_{θ} k\end{matrix} ]$$

where E_{θ} and F_{θ} are the observer gain matrices for the pitch observer, where B_{θ} and D_{θ} is a bound gain parameter, where x_{θ}[k] is an estimated pitch state, and where û_{θ}[k] is an estimate of an unknown input.

The following observer is used to estimate the road bank angle (Φᵣ) for the roll state as follows:

$${Φ}_{r} [ k ] = {sin}^{- 1} ( \frac{{\hat{u}}_{φ} [ k ] - {\dot{v}}_{y} [ k ] - {v}_{x} [ k ] \dot{ψ} [ k ]}{g} ) - {\dot{Φ}}_{v} [ k ] .$$

In addition, the following observer is used to estimate the road grade angle (Θᵣ) for the pitch state as follows:

$${Θ}_{r} [ k ] = {sin}^{- 1} ( \frac{{\hat{u}}_{θ} [ k ] - {\dot{x}}_{y} [ k ] - {v}_{y} [ k ] \dot{ψ} [ k ]}{g} ) - {\dot{θ}}_{v} [ k ]$$

The following inputs are used in the model as derived through a sprung mass kinematic model. The sprung mass kinematics is used to estimate the suspension height at each corner of a vehicle using the measurements from sensors installed on the other three corners of a vehicle as represented by FIG. 5. The roll angle (φᵥ) and the pitch angle (θᵥ) of the vehicle body are estimated using suspension height sensors at each corner. These multiple estimates will be used in the following equations for detection and reconstruction of the sensor faults.

In step 61, sensory inputs read or estimated. Sensory inputs include, but are not limited to, suspension heights (Δ_{zij}), roll rate (\dot{φ}ᵥ), yaw rate (\dot{ψ}), longitudinal and lateral acceleration components (\dot{v}_{y}, \dot{v}ₓ), and wheel angular velocity (ωᵢⱼ).

In step 62, a determination is made as to whether re-initialization is required, such as the vehicle being stationary. If vehicle is stationary, then the routine proceeds back to step 60; otherwise, the routine proceeds to step 63.

In step 63, a suspension height (Δzᵢⱼ) is determined based on the measured height.

In step 64, an estimated (virtual) suspension height is determined. With the schematic of the sprung mass vehicle model (shown in FIG. 5), the position of the virtual suspension heights for each corner can be estimated using the sensors installed on the other three corners as:

[symbol]

=−( [symbol] ₋ᵢⱼ^{x} [symbol] ᵢⱼ^{x}+ [symbol] ₋ᵢⱼ^{y} [symbol] ᵢⱼ^{y}+d₋ᵢⱼ)/ [symbol] ₋ᵢⱼ^{z}

where geometric functions [symbol] ₋ᵢⱼ^{x}, d₋ᵢⱼ, [symbol] ᵢⱼ^{x}, and [symbol] ᵢⱼ^{y} are calculated using corner positions. The subscript ij ε {fl, fr, rl, rr} indicates front-left (fl), front-right (fr), rear-left (rl), and rear-right (rr) corners, and [symbol] is the estimated suspension height. The subscript −ij represents a scenario in which the suspension height provided by the sensor ij is not used in the calculations. Furthermore, the estimated roll angle \hat{φ}₋ᵢⱼ and pitch angle \hat{θ}₋ᵢⱼ when the suspension height sensor ij is not used can be written as:

$${\hat{φ}}_{- ij} = {cos}^{- 1} \frac{{N}_{- ij}^{y}}{‖ {N}_{- ij} ‖} . \\ {\hat{θ}}_{- ij} = {cos}^{- 1} \frac{{N}_{- ij}^{x}}{‖ {N}_{- ij} ‖}$$

These estimates are used as inputs to the roll and pitch dynamics observers.

As a result, the virtual suspension height utilizes indirect sensor data that are not necessarily dedicated to detecting the suspension height at that location, but can be utilized cooperatively with other data to determine the virtual suspension height for the respective location.

In step 65, the residuals are determined based off of the measured suspension heights and the virtual suspension heights. That is, a residual (R_{z}_{ᵢⱼ}) for the suspension height is determined as a difference between the measured suspension height (Δzᵢⱼ) and the virtual suspension height ( [symbol] ). The four residuals are determined at each corresponding location. The residual for the suspension height is determined by the following formula:

R_{z}_{ᵢⱼ}=|Δzᵢⱼ− [symbol] |.

Furthermore, a residual (R_{\dot{φ}-ij}) for the roll rate is determined as a difference between the measured roll rate (\dot{φ}ₛ) and the virtual roll rate (\hat{\dot{φ}}₋ᵢⱼ) estimated by using the observer. The residual for the virtual roll rate is determined by the following formula:

R_{\dot{φ}-ij}=|\dot{φ}ₛ−\hat{\dot{φ}}₋ᵢⱼ|.

Similarly, a residual (R_{\dot{θ}-ij}) for the pitch rate is determined as a difference between the measured pitch rate (\dot{θ}ₛ) and the virtual pitch rate (\hat{\dot{θ}}₋ᵢⱼ) estimated using the observer. The residual for the virtual pitch rate is determined by the following formula:

R_{\dot{θ}-ij}=|\dot{θ}ₛ−\hat{\dot{θ}}₋ᵢⱼ|.

In step 66, an instantaneous adaptive fault threshold is determined for the suspension height to be compared against the residual. The formula for determining the instantaneous adaptive fault threshold is as follows:

T_{z}=Bₛ_{_{z}}+B_{d}_{_{z}}(|aₓ|+|a_{y}|)

where Bₛ_{_{z}} is a static bound that determines a fixed minimum value for the threshold, and B_{d}_{_{z}} is a constant gain that adds effects of longitudinal and lateral excitations to the residual threshold.

In step 67, to enhance the robustness of the technique against false positives in transient regions, evaluation of an instantaneous adaptive fault threshold is performed over a time window and is represented as follows:

T_{d}_{_{z}}=max(T_{z}(k), T_{z}(k−1) . . . , T_{z}(k−W_{z}))

where W_{z} is the length of the time window and T_{d}_{_{z}} is the dynamic fault threshold.

In step 68, a comparison is made as to whether the residual exceeds the dynamic adaptive fault threshold. When no failures are present in the system, residuals fall below a dynamic adaptive fault threshold. A check is made to determine whether the residuals exceed the dynamic adaptive fault threshold as represented by the following condition:

(R_{z}_{ᵢⱼ}>T_{d}_{_{z}}).

If the residual exceeds the dynamic adaptive fault threshold, then the routine proceeds to step 69; otherwise the routine advances to step 72.

In step, 69, in response to the residual exceeding the dynamic adaptive fault threshold, fault state counter (n_{z}_{ᵢⱼ}) that is initially set to zero is incremented as represented by the following formula:

n_{z}_{ᵢⱼ}(k)=n_{z}_{ᵢⱼ}(k−1)+1.

Although every single incident of crossing the threshold can be treated as a fault, practically and by definition, a fault should persist over a period of time to be labeled as a fault. Therefore, in step 70 a determination is made as to whether the fault is persistent. The check is made if a residual R_{z}_{ᵢⱼ} is above the dynamic adaptive fault threshold (i.e., the fault persists) for N_{z} consecutive samples times (n_{z}_{ᵢⱼ}>N_{z}). If the condition holds true, then the routine proceeds to step 71; otherwise the routine advances to step 78.

In step 71, in response to the determination that the fault is persisting, the faults state (S_{z}_{ᵢⱼ}) is set to 1.

In step 72, a determination is made as to whether the fault state (S_{z}_{ᵢⱼ}) is set to 1. If the fault state is set to 1, then the routine proceeds to step 73; otherwise, the routine proceeds to step 75.

A failure for each corner will result in all four residuals exceeding the thresholds, and subsequently, four fault states are perceived and the corresponding flag is set to 1. As a result, the fault may not yet be localized only by using the suspension height sensors. Consequently, the four fault states (S_{z}_{ᵢⱼ}), which have the same value all the time, can be combined into a single fault state (S_{z}). Localization of the fault will be performed using the roll and pitch rate residuals and a fault signature table.

In step 73, the faulty sensor is identified using fault signature table. The detection and localization of a fault is identified using the residuals as described earlier. An example is considered where the suspension height sensors and the pitch rate sensors are healthy and the roll rate sensor is faulty. Under such conditions, the inputs to the roll observer (\hat{φ}ᵥ_{_{−ij}}) is correct as these inputs are calculated using the healthy suspension height sensors. Therefore, the observer can accurately estimate the vehicle's roll rate (\hat{φ}ₛ_{_{−ij}}). Since the roll rate sensor is faulty, none of these four estimated roll rates form the observer ( [symbol] ₛ_{_{−ij}}) match the measured roll rate from the faulty sensor (\dot{φ}ₛ). Therefore, the roll residuals exceed the thresholds and result in four roll fault states equal to 1 ([S_{φ}_{_{−fl}} S_{φ}_{_{−fr}} S_{φ}_{_{−rl}} S_{φ}_{_{−rr}}]=[1 1 1 1 ]). In a similar scenario, the fault state for the suspension heights is equal to zero [S_{z}]=[0] since none of these sensors are faulty and the suspension residuals fall below the thresholds. Similarly, the pitch rate residuals all fall below their respective threshold and the input to the pitch observer is not affected by any fault. Therefore, the pitch rate fault states are all equal to zero ([S_{θ}_{_{−fl}} S_{θ}_{_{−fr}} S_{θ}_{_{−rl}} S_{θ}_{_{−rr}}]=[0 0 0 0 ]). Combining the faults states described herein generates a fault signature ([S_{z} S_{φ}_{_{−fl}} S_{φ}_{_{−fr}} S_{φ}_{_{−rl}} S_{φ}_{_{−rr}} S_{θ}_{_{−fl}} S_{θ}_{_{−fr}} S_{θ}_{_{−rl}} S_{θ}_{_{−rr}}]=[0 1 1 1 1 0 0 0 0 ]) for the roll rate sensor failure.

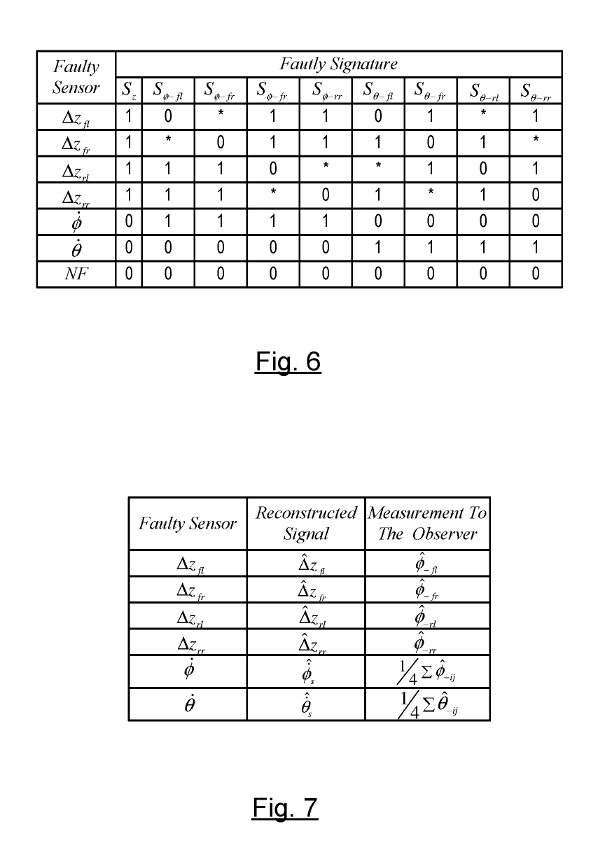

Therefore, the same technique regarding fault signatures can be assigned to each possible sensor failure as shown in the table of FIG. 6. As an example, the table in FIG. 6 shows that the failure of the front-left suspension height sensor generates the unique fault signature ([S_{z} S_{φ}_{_{−fl}} S_{φ}_{_{−fr}} S_{φ}_{_{−rl}} S_{φ}_{_{−rr}} S_{θ}_{_{−fl}} S_{θ}_{_{−fr}} S_{θ}_{_{−rl}} S_{θ}_{_{−rr}}]=[1 0 * 1 1 0 1 * 1]) where *ε {0 1} represents an insignificant fault state in the decision making process. Consequently, a failure of each sensor can be detected and localized using the fault signatures in the table shown in FIG. 6.

In step 74, the faulted sensor relating to the suspension height can be reconstructed using the estimated states in the table shown in FIG. 7 as a result of the identified fault signature. Observers can still be used to estimate the road bank and grade angles if provided with the respective measurement signal. After reconstructing the signal, the routine proceeds to step 76.

In step 75, in response to the determination in step 72 that the fault state is not equal to 1, the fault state count is reset. The routine proceeds to step 76.

In step 76, the fault free suspension height signal is provided to an estimation and control module.

In step 77, the fault state is passed to the estimation and control module.

In step 78, the routine waits for the next set of sample data. After receiving the next set of sample data, the routine returns to step 61 where sensory estimated inputs are obtained and recorded.

While certain embodiments of the present invention have been described in detail, those familiar with the art to which this invention relates will recognize various alternative designs and embodiments for practicing the invention as defined by the following claims.

What is claimed is:

1. A method of reconstructing a detected faulty signal comprising the steps of:
detecting a suspension height sensor fault by a processor;
reconstructing, by a processor, a signal of the detected faulty suspension height sensor using indirect sensor data; and
outputting the reconstructed signal to a controller to maintain stability.

2. The method of claim 1 wherein detecting the suspension height sensor fault by the processor comprises the steps of:
obtaining sensory data from a faulted suspension height sensor, the faulted suspension height sensor dedicated to monitor a suspension height;
obtaining sensory data from other suspension height sensors disposed at different locations;
determining a virtual sensor value as a function of the sensory data from the other suspension height sensors;
generating a residual as a function of the sensory data from the faulted suspension height sensor and virtual sensor value from the other suspension height sensors;
comparing the residual to a threshold;
detecting the suspension height sensor fault in response to the residual exceeding the threshold.

3. The method of claim 2 wherein determining a virtual sensor value is determined by the following formula: [symbol]
=−( [symbol] ₋ᵢⱼ^{x} [symbol] ᵢⱼ^{x}+ [symbol] ₋ᵢⱼ^{y} [symbol] ᵢⱼ^{y}+d₋ᵢⱼ)/ [symbol] ₋ᵢⱼ^{z}
where geometric functions [symbol] ₋ᵢⱼ^{x}, d₋ᵢⱼ, [symbol] ᵢⱼ^{x}, [symbol] ᵢⱼ^{y} are calculated using corner positions, subscript ij ε {fl, fr, rl, rr} indicates front-left (fl), front-right (fr), rear-left (rl), and rear-right (rr) corners, and [symbol] is the estimated suspension height.

4. The method of claim 3 wherein the threshold includes a dynamic adaptive threshold.

5. The method of claim 4 wherein the dynamic adaptive threshold is estimated based on a current driving condition and dynamic region.

6. The method of claim 5 wherein the current driving conditions and dynamic region are determined using the vehicle model and sensory data.

7. The method of claim 4 wherein the dynamic adaptive threshold is determined utilizing the following equation:
T_{d}_{_{z}}=max(T_{z}(k), T_{z}(k−1) . . . , T_{z}(k−W_{z}))
where W_{z} is the length of the time window and T_{z} is an instantaneous adaptive fault threshold.

8. The method of claim 7 wherein the instantaneous adaptive threshold is determined utilizing the following equation:
T_{z}=Bₛ_{_{z}}+B_{d}_{_{z}}(|aₓ|+|a_{y}|)
where Bₛ_{_{z}} is a static bound that determines a fixed minimum value for the threshold, and B_{d}_{_{z}} is a constant gain that adds effects of longitudinal and lateral excitations to the residual threshold.

9. The method of claim 8 wherein generating the residual as a function of the sensory data measured from the faulted suspension height sensor and the virtual sensor value determined from the other suspension height sensors is determined by the following equation:
R_{z}_{ᵢⱼ}=|Δzᵢⱼ− [symbol] |.
wherein [symbol] is the virtual suspension height and Δzᵢⱼ is the measured suspension height.

10. The method of claim 1 wherein detecting the sensor fault in response to the residual exceeding the threshold further comprises the step of determining whether the fault persists for a period of time.

11. The method of claim 10 wherein determining whether the fault persists for the period of time further comprises the steps of:
incrementing a fault count each time the residual exceeds the threshold;
detecting the fault when the fault count exceeds a predetermined count threshold.

12. The method of claim 11 wherein the fault count is reset to zero in response to a residual not exceeding the threshold.

13. The method of claim 1 wherein reconstructing the signal of the detected faulty sensor is based on a fault signature.

14. The method of claim 13 wherein the fault signature is selected from a plurality of predetermined fault signatures, wherein each fault signature includes a fault state for each roll state and each pitch state at each respective location of each suspension height sensor.

15. The method of claim 14 wherein each roll state is determined as a function of a determining a virtual sensor value as a function of the sensory data from the at least one non-faulted sensor is determined utilizing a roll dynamics of a vehicle model and is represented by the following formula:
$$[ \begin{matrix}{\dot{φ}}_{v} \\ {\ddot{φ}}_{v}\end{matrix} ] = [ \begin{matrix}0 & 1 \\ \frac{- {K}_{φ}}{( {I}_{x} + {m}_{s} {H}_{RC}^{2} )} & \frac{- {C}_{φ}}{( {I}_{x} + {m}_{s} {H}_{RC}^{2} )}\end{matrix} ] [ \begin{matrix}{φ}_{v} \\ {\dot{φ}}_{v}\end{matrix} ] + [ \begin{matrix}0 \\ \frac{{m}_{s} {H}_{RC}}{( {I}_{x} + {m}_{s} {H}_{RC}^{2} )}\end{matrix} ] [ {\dot{v}}_{y} + {v}_{x} \dot{ψ} + g sin ( {φ}_{v} + {Φ}_{r} ) ] ,$$
where φᵥ is the roll angle of the sprung mass, \dot{φ}ᵥ is the vehicle roll rate, Φᵣ is the road bank angle, H_{RC} represents a distance between a center of gravity and the roll center, Iₓ represents a moment of inertia about the x axes of a body coordinate system; \dot{v}_{y} is the lateral acceleration; vₓ represents longitudinal velocity; \dot{ψ} is the yaw rate; Φᵣ is the road bank angle; mₛ is the sprung mass; g is the gravitational acceleration; C_{φ} is the roll damping; K_{φ} is the stiffness coefficients for roll.

16. The method of claim 15 wherein an observer is applied to estimate the roll state with an unknown input for determining a fault, the observer represented by the following equation:
$${\hat{x}}_{φ} [ k + 1 ] = {E}_{φ} {\hat{x}}_{φ} [ k ] + {F}_{φ} {y}_{φ} [ k \text{:} k + L ]$$
$${\hat{u}}_{φ} [ k ] = {[ \begin{matrix}{B}_{φ} \\ {D}_{φ}\end{matrix} ]}^{- 1} [ \begin{matrix}{\hat{x}}_{φ} [ k + 1 ] - {A}_{φ} {\hat{x}}_{φ} [ k ] \\ {y}_{φ} [ k ] - {C}_{φ} {x}_{φ} k\end{matrix} ]$$
where E_{φ} and F_{φ} are the observer gain matrices for the roll observer, where B_{φ} and D_{φ} are bound gain parameters, where x_{φ}[k] is an estimate roll state, and where ŷ_{φ}[k] is an estimate of an unknown input.

17. The method of claim 14 wherein determining a virtual sensor value as a function of the sensory data from the at least one non-faulted sensor is determined utilizing a pitch dynamics of a vehicle model and is represented by the following formula:
$$[ \begin{matrix}{\dot{θ}}_{v} \\ {\ddot{θ}}_{v}\end{matrix} ] = [ \begin{matrix}0 & 1 \\ \frac{- {K}_{θ}}{( {I}_{y} + {m}_{s} {H}_{RC}^{2} )} & \frac{- {C}_{θ}}{( {I}_{y} + {m}_{s} {H}_{RC}^{2} )}\end{matrix} ] [ \begin{matrix}{θ}_{v} \\ {\dot{θ}}_{v}\end{matrix} ] + [ \begin{matrix}0 \\ \frac{{m}_{s} {H}_{RC}}{( {I}_{y} + {m}_{s} {H}_{RC}^{2} )}\end{matrix} ] [ - {\dot{v}}_{x} + {v}_{y} \dot{ψ} + g sin ( {θ}_{v} + {Θ}_{r} ) ]$$
where θᵥ is the pitch angle of the sprung mass, respectively; \dot{θ}ᵥ is the vehicle pitch rates; H_{PC} represents a distance between a center of gravity and the pitch center; I_{y} represents moments of inertial about the y axis of the body coordinate system; v_{y} is the lateral velocity; \dot{v}ₓ represents longitudinal acceleration; \dot{ψ} is the yaw rate; Θᵣ is the road grade angle; mₛ is the sprung mass; g is the gravitational acceleration; C_{θ} is the pitch damping; and K_{θ} is the stiffness coefficient for pitch.

18. The method of claim 17 wherein an observer is applied to estimate a pitch state with an unknown input for determining a fault, the observer represented by the following equation:
$${\hat{u}}_{θ} [ k ] = {[ \begin{matrix}{B}_{θ} \\ {D}_{θ}\end{matrix} ]}^{- 1} [ \begin{matrix}{\hat{x}}_{θ} [ k + 1 ] - {A}_{θ} {\hat{x}}_{θ} [ k ] \\ {y}_{θ} [ k ] - {C}_{θ} {x}_{θ} k\end{matrix} ]$$
where E_{φ} and F_{φ} are the observer gain matrices for the pitch observer, where B_{θ} and D_{θ} are bound gain parameters, where x_{θ}[k] is an estimate pitch state, and where û_{θ}[k] is an estimate of an unknown input.

19. The method of claim 1 wherein outputting the signal to a controller to maintain stability includes outputting the signal to a vehicle braking system for mitigating a vehicle instability condition.

20. The method of claim 1 wherein the outputting signal to a controller to maintain stability includes outputting the signal to a powertrain control system for mitigating a vehicle instability condition.

21. The method of claim 1 wherein the outputting signal to a controller to maintain stability includes outputting the signal to a vehicle traction control system for mitigating a vehicle instability condition.

22. The method of claim 1 wherein outputting the signal to a controller to maintain stability includes outputting the signal to a steering system for mitigating a vehicle instability condition.
